(19) United States
(12) Patent Application Publication
(10) Pub. No.: US 2009/0210192 A1
(43) Pub. Date: Aug. 20, 2009

(54) Method of Assessing Energy Efficiency of Buildings

(75) Inventor: Haithan K. Askar, Milton Keynes (GB)

Correspondence Address: STERNE, KESSLER, GOLDSTEIN & FOX P.L.L.C., 1100 NEW YORK AVENUE, N.W., WASHINGTON, DC, 20005, US

(73) Assignee: Spelthorne Borough Council, Staines, Middlesex (GB)

(21) Appl. No.: 11/816,260

(22) PCT Filed: Feb. 21, 2006
(86) PCT No.: PCT/GB2006/000598

§ 371 Date: Oct. 17, 2008

(30) Foreign Application Priority Data
Feb. 28, 2005 (GB) 0504077.9

(51) Int. Cl. G06F 15/00; G01N 25/18

(52) U.S. Cl. 702/136

(57) ABSTRACT

A method of identifying, from an aerial thermal image (1) of a plurality of buildings within a predetermined area, those buildings having relatively low thermal efficiency, comprises performing ground-based measurements (2, 3) indicative of the thermal efficiency of a sample of the buildings; correlating (4) the ground-based measurements (2, 3) with the aerial thermal image (1) and estimating (6), on the basis of the correlation (5), which ones of the buildings, other than those of the sample, have relatively low thermal efficiency.

### FIELD OF THE INVENTION

The present invention relates to a method of assessing the energy efficiency of buildings, particularly but not exclusively for identifying buildings of low thermal efficiency.

### BACKGROUND OF THE INVENTION

As the cost of energy for heating rises, and awareness increases of the environmental impact of wasted energy, it has become desirable to survey an area for buildings that are poorly insulated or otherwise using energy inefficiently.

Internationally, the Kyoto Protocol requires signatory states to implement policies to enhance energy efficiency. Within the UK, the Home Energy Conservation Act 1995 imposes a duty on local authorities to identify energy inefficient buildings and to take remedial steps. A Housing Health and Safety Rating System (HHSRS) has been devised for the assessment of buildings, including an assessment of their thermal performance. The recommended thermal rating system is the Standard Assessment Procedure (SAP), which quantifies the energy efficiency of a building on a scale of 1-100. Other ratings systems, such as the National Home Energy Rating (NHER) system, may also be used.

To rate the thermal efficiency of a building using either SAP or NHER requires a detailed survey of the building, including a floor plan, elevations, details of the construction of walls, roof, doors and windows, and details of the heating system. It is not practicable for a local authority, with responsibility for 10,000-100,000 buildings or more, to survey each one. Instead, in a conventional method of attempting to identify thermally inefficient buildings, a representative sample of buildings is surveyed, and the results extrapolated to other buildings within the area of responsibility. Additional information on the unsurveyed buildings may be gathered from mail shots or electoral registers, for example. However, this additional information is often inconclusive and may be inaccurate.

As a general method of surveying thermal losses from buildings, it is known to obtain an aerial thermal image of an area, which is inspected visually for signs of excessive heat loss. The image may be compared with a map of the area, to identify the building from which the heat loss emanates. For example, a paper entitled ‘Monitoring Building Heat Loss—Airborne Thermal Infrared’, by Paul Gray, available on 22 Feb. 2005 at http://www.infoterra-global.com/pdfs/thermal_gg.pdf describes how an aerial thermal image may be cross-referenced to other data sources such as geographical information or energy ratings, to identify buildings having the worst heat loss problems. This paper acknowledges that anomalies may occur when interpreting aerial thermal images. For example, a building that appears relatively cool in the image may be either well heated but well insulated, or under-heated and badly insulated. The paper concludes that such anomalies are unavoidable, but should not detract from the overall value of the aerial thermal image for heat-loss detection. However, under-heated and badly insulated buildings are precisely those buildings that the local authority is required to identify and remedy.

Thus, there remains a need to identify more reliably those buildings that have low thermal insulation characteristics.

### STATEMENT OF THE INVENTION

According to one aspect of the present invention, there is provided a method of identifying buildings having relatively low thermal efficiency, the method comprising: obtaining aerial thermal images of a set of buildings; performing ground-based measurements of a subset of the buildings; correlating the ground-based measurements of the subset with the corresponding aerial images; and estimating, on the basis of the correlation, ones of the buildings, other than those of the subset, have relatively low thermal efficiency.

Preferably, the correlating and/or estimating steps involve the use of a geostatistical technique dependent on the spatial distribution and variation of the measured subset. The geostatistical technique may be a Kriging technique, such as Ordinary Kriging (OK) or Indicator Kriging (IK).

The ground-based measurements may include a thermal efficiency rating and/or a ground-based thermal image. The ground-based thermal image provides information on the thermal performance of buildings, which is not apparent from aerial thermal images alone. However, there is some overlap between the information obtained from aerial and ground-based thermal imaging. This overlap may be used to correlate the ground-based measurements with the aerial measurements. This correlation may be used to estimate the thermal properties of those buildings that have not been surveyed from the ground.

The thermal efficiency rating of the subset of buildings may be derived using physical measurements and/or historical data of the construction of those buildings. The thermal efficiency may be quantified by an objective rating. The thermal efficiency of the unsurveyed buildings may also be estimated using the same rating.

The method may involve using a geographical database identifying the geographical location of the buildings, so that the buildings estimated to have low thermal efficiency are identified by location.

he method is preferably implemented by a computer system, which takes as its input the aerial thermal images, the ground-based measurements and optionally, the geographical database. The computer system correlates the aerial thermal images of the subset with their ground-based measurements to derive a relationship, which is then applied to the aerial thermal images of the buildings not within the subset, so as to output a estimated thermal rating of those buildings. The output may comprise a database of estimated thermal efficiency ratings for specific ones of those buildings, or of groups of those buildings. The estimated thermal efficiency ratings may be displayed on a map of the area, to assist a user in identifying buildings estimated to have a low thermal efficiency rating. Embodiments of the present invention include a computer program comprising program code arranged to implement the above system and method, a computer system for executing the program code, and a medium for carrying the computer program.

### BRIEF DESCRIPTION OF THE DRAWINGS

Specific embodiments of the present invention will now be illustrated with reference to the accompanying drawings, in which:

FIG. 1 is a schematic diagram of a method in an embodiment of the invention;

FIG. 2 is a composite aerial thermal image of an area;

FIG. 3 is an enlarged section of the aerial thermal image of FIG. 3;

FIG. 4 is a processed image showing temperature differences in the aerial thermal image; and

FIG. 5 is a ground-level thermal image of a building located within the area.

### DETAILED DESCRIPTION OF THE EMBODIMENTS

Aerial Thermal Image

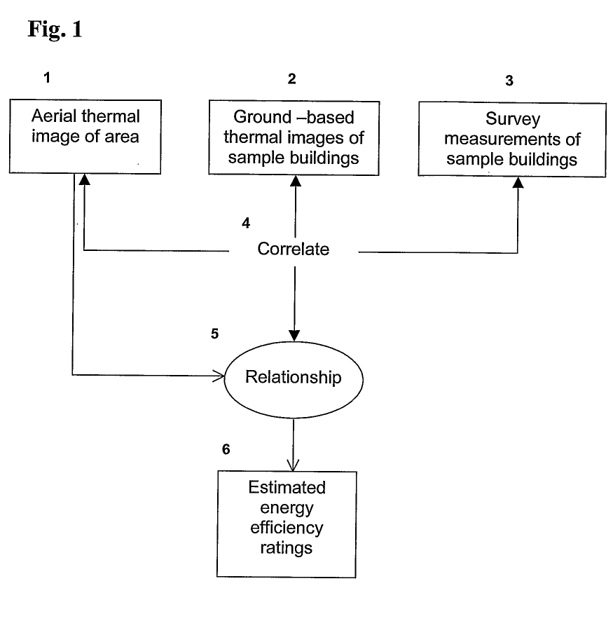

A method according to an embodiment of the invention is illustrated in FIG. 1. According to this method, an aerial thermal image 1 is taken of an area containing buildings for which the thermal efficiency is to be estimated. The aerial thermal image 1 is taken under conditions selected so as to emphasize thermal effects caused by internal heating and heat loss from buildings, and to minimize the effect of solar heating. Preferably, the aerial thermal image is taken in cold weather conditions at a time when the interiors of the buildings are likely to have been heated to their normal temperature by internal heating systems, but the effect of solar heating is minimal; for example, 8 to 10 pm and/or the early hours in the morning.

The aerial thermal image 1 is preferably taken using a digital infrared camera mounted on an aircraft overflying the area at a substantially constant altitude. If the desired area cannot be imaged by one pass of the aircraft, then images of sections (normally strips in the case of fixed wing aircraft) of the area are taken, and spliced together using image processing software.

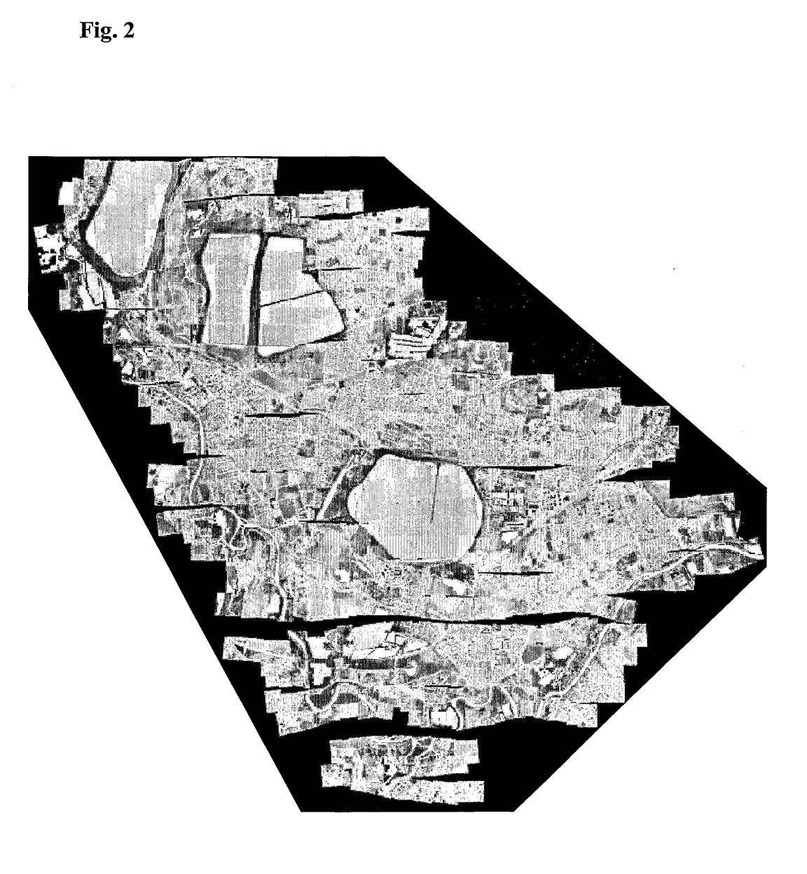

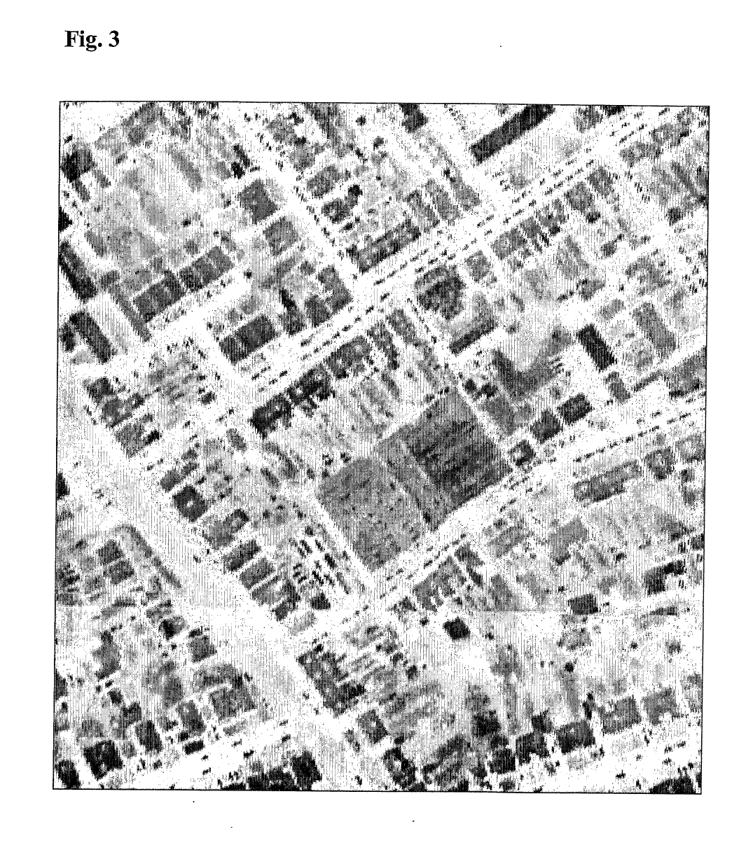

An example of a composite aerial thermal image 1 is shown in FIG. 2, which is an image of the area of the Borough of Spelt Horne, composed of many small thermal images taken over a two-day period and normalised for ambient temperature. Darker parts of the image represent cooler parts of the area. Some parts were not imaged, as shown by the blank strips in the image. FIG. 3 shows an enlarged section of the image.

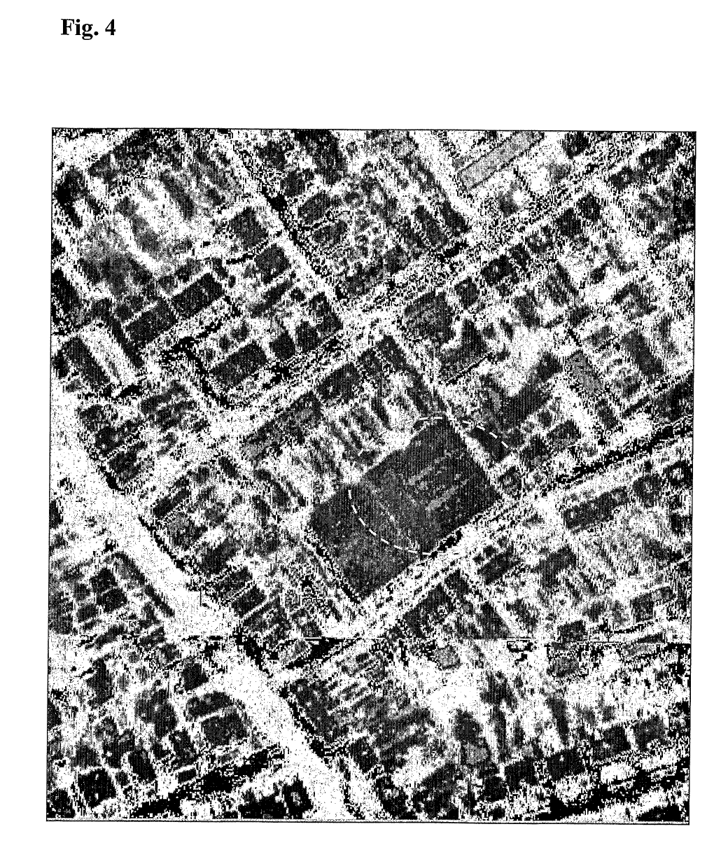

The aerial thermal image 1 may converted to a standardized form indicative of temperature differences between the buildings or between the buildings and the mean outside temperature. Standardized thermal images of this type are commonly generated as colourized images, to highlight areas of high heat loss. FIG. 4 shows a standardized version of the image of FIG. 3. Cooler roads can be distinguished from warmer buildings and cars in the image. The large building highlighted with a dashed circle is a metal-framed warehouse showing warm patches, and therefore high heat loss.

Ground-Based Thermal Images

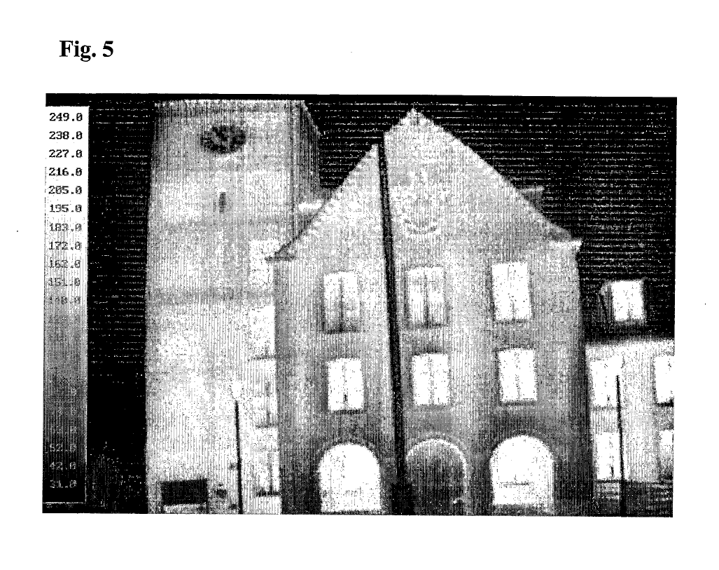

Ground-based thermal images 2 are obtained from a sample of the buildings shown in the aerial thermal image 1. The sample of buildings is preferably chosen so as to cover a wide range of different types of building, at varying locations. The ground-based thermal images 2 may be taken using an infrared camera mounted on or near the ground (for example, on a crane). From the ground-level thermal images 2, it is possible to distinguish between well-heated, well-insulated buildings and poorly heated, poorly insulated buildings, which may appear similar from the aerial thermal image 1. For example, thermal images of side elevations will show the effect of the variation in thermal insulation between windows and external walls, and therefore indicate the level of internal heating within the building. An example of such a thermal image is shown in FIG. 5, which is an infrared image of the East entrance to the Spelthorne Borough Council offices. The warmer windows are contrasted with the cooler exterior walls, illustrating their different thermal insulation properties.

The ground-based thermal images 2 are processed to derive values for standardized parameters, so that different thermal images 2 may be compared quantitatively.

Survey Measurements

Measurements 3 are obtained by surveying some or all of the sample of buildings from which ground-based thermal images were taken. The measurements 3 are indicative of the thermal efficiency of the buildings, including the surface area of elevations and roofs, and/or historical data such as the type of construction of the buildings. For example, historical records may show that a building is of British Iron and Steel Foundation (BISF) modular type; this data could also be obtained by invasive measurement techniques.

Preferably, the survey measurements 3 are processed to derive an energy efficiency rating for that building, representing an overall objective measurement of the thermal efficiency of the building on a standard scale. The scale may be an SAP or NHER scale.

Geographical Information

The method may use geographical information identifying the known locations of buildings within the area covered by the aerial thermal image. The geographical information may identify the addresses and/or postal codes of buildings at specified geographical locations. The geographical information may be used to correlate the ground-based measurements with the corresponding areas of the aerial thermal image 1.

Correlation of Ground Survey Data and Aerial Thermal Properties

As described above, there is available for the sample of buildings an aerial thermal image 1, ground-based thermal images 2, and survey measurements 3. The method correlates 4 these three sets of data for the sampled buildings so as to derive a general relationship 5 between properties of the aerial image 1, properties of the ground-based thermal images 2 and the survey measurements 3 of the sampled buildings. The relationship 5 may be a statistical model dependent on the locations of the sampled buildings.

In one example, the relationship 5 is a geostatistical model. A preferred geostatistical model uses a linear unbiased estimator, such as a Kriging technique. Either Ordinary Kriging (OK) or Indicator Kriging (IK) may be used. Kriging techniques are described for example in ‘An Introduction to Applied Geostatistics’, Isaaks E H and Srivastava R M, Oxford University Press 1989. Alternative techniques, such as fuzzy logic, may be used to construct the relationship 5.

Estimation of Thermal Efficiencies of Unsampled Buildings

The properties of the aerial thermal image 1 for the unsampled buildings are then converted to estimated thermal efficiency ratings 6 of the unsampled buildings, using the relationship 5. For example, the aerial thermal image 1 may be input to the geostatistical model together with the geographical information indicating the location of the unsampled buildings. The model may generate as output the corresponding estimated thermal efficiency ratings 6 of the unsampled buildings.

The estimated thermal efficiency ratings 6 may be output in the form of a digital map representing the location and estimated efficiency ratings 6 of the buildings within the area. The map helps the user to identify areas of estimated low thermal efficiency within the area.

Additionally or alternatively, the method may apply a threshold to the estimated efficiency ratings 6, and output a list of buildings having estimated efficiency ratings below the threshold. For example, the user may wish to identify all buildings estimated to have a SAP rating below the national average of 44-46. The user inputs the desired threshold and the method outputs a list of buildings with estimated SAP ratings below that threshold. The buildings may be identified by address, location and/or postal code, derived from the geographical information.

The method may provide good estimations of thermal efficiency of unsampled buildings, and may therefore reduce the need to conduct full ground surveys of buildings within the area. If these estimations are followed by remedial action to improve the thermal efficiency of those buildings identified as having poor thermal efficiency, then heat loss from buildings within the area may be significantly improved, resulting in lower consumption of fuel for heating and a consequent saving in carbon dioxide emissions.

Updating the Relationship

The relationship 5 may be updated by providing additional ground-based thermal images 2 and/or survey measurements 3 as input. For example, the buildings estimated as having the lowest thermal efficiency may be surveyed to generate ground-based thermal images 2 and measurement data 3, which are provided as input to update the relationship 5 to fit the new data. The aerial images 1 of the unsampled buildings are then reprocessed using the updated relationship 5 so as to obtain an improved estimate of their thermal efficiency. In other words, the relationship 5 is updated recursively so as to improve its estimations of buildings with the lowest thermal efficiency.

Computer System, Program and Medium

The method is preferably implemented by a computer system executing a program to perform the method shown in FIG. 1. The computer system may comprise a computer having access to the aerial thermal image 1 and the relationship 5, so as to estimate the energy efficiency ratings 6. The aerial thermal image 1, the ground-based thermal images 2 and the survey measurements 3 may be pre-processed by another computer or computers to derive the relationship 5.

The computer program may be recorded on a program carrier or medium, such as a removable or fixed disk or solid-state memory, or incorporated in a signal.

### Alternative Embodiments

The embodiments described above are illustrative of rather than limiting to the present invention. Alternative embodiments apparent on reading the above description may nevertheless fall within the scope of the invention. For example, it is not necessary to estimate the thermal efficiency of all buildings within the area, if it is desired only to identify those buildings having a low estimated thermal efficiency.

1. A computer-implemented method of estimating the thermal efficiency of a specified building within a predetermined area, comprising the steps of:
(a) accessing aerial measurements of thermal properties of buildings within the area, including the specified building;
(b) accessing data representing ground-based measurements of a subset of the buildings, excluding the specified building;
(c) deriving a relationship between the aerial measurements and the ground-based measurements of the subset; and
(d) applying the relationship to the aerial thermal measurement of the specified building so as to estimate the thermal efficiency of the specified building.

2. The method of claim 1, wherein the relationship is a geostatistical model dependent on the spatial distribution of the subset of the buildings.

3. The method of claim 2, wherein the geostatistical model uses a linear unbiased estimator.

4. The method of claim 1, wherein the ground-based measurements of the subset of the buildings include ground-based thermal measurements.

5. The method of claim 1, wherein the ground-based measurements of the subset of the buildings include measurements indicative of thermal efficiency.

6. The method of claim 1, wherein the aerial measurements of the thermal properties of the buildings are derived from an aerial thermal image.

7. The method of claim 1, including determining whether the specified building has an estimated thermal efficiency below a predetermined level.

8. The method of claim 7, further including, if the specified building is estimated to have a thermal efficiency below the predetermined level, updating the relationship so as to include ground-based measurements of the specified building.

9. A computer-implemented method of identifying, from a set of buildings within an area, one or more buildings likely to have a low thermal efficiency, comprising the steps of:
(a) performing ground-based measurements indicative of the thermal efficiencies of a subset of the buildings;
(b) obtaining an aerial thermal image of the area;
(c) correlating the ground-based measurements with the aerial thermal image to derive a relationship therebetween; and
(d) applying the relationship to the aerial thermal image to identify the one or more buildings likely to have a low thermal efficiency.

10. An article of manufacture comprising a computer-readable medium for storing computer instructions that enable a processor-based system to perform operations including:
(a) accessing aerial measurements of thermal properties of buildings within an area, including a specified building;
(b) accessing data representing ground-based measurements of a subset of the buildings, excluding the specified building;
(c) deriving a relationship between the aerial measurements and the ground-based measurements of the subset; and
(d) applying the relationship to the aerial thermal measurement of the specified building so as to estimate thermal efficiency of the specified building.
